(19) United States
(12) Patent Application Publication
(10) Pub. No.: US 2003/0074284 A1
(43) Pub. Date: Apr. 17, 2003

(54) System and method for forecasting material requirements and managing the accessability of the materials

(75) Inventor: Rickie Boyd Bowden, Houston, TX (US)

Correspondence Address: MORGAN LEWIS & BOCKIUS LLP, 1111 PENNSYLVANIA AVENUE NW, WASHINGTON, DC, 20004, US

(73) Assignee: Sumitomo Corporation of America

(21) Appl. No.: 09/977,286

(22) Filed: Oct. 16, 2001

(51) Int. Cl. G06F 17/60

(52) U.S. Cl. 705/28

(57) ABSTRACT

An inventory management system is provided, comprising customer inquiry/quotation means for obtaining inventory and non-inventory product information, forecasting means for identifying planned sales, sales order means for providing general information about the sale, the products, charges and services required to produce end products, purchase order means for receiving and providing product and specification information to the supplier and accepting and generating an identifier for the purchase, reporting means for presenting information to a user of the system, adjusting means for modifying inventory information and, query means for viewing inventory and transaction information.

### BACKGROUND OF THE INVENTION

1. Field of the Invention

The present invention relates to a method and a system for forecasting materials requirements and managing the accessibility of those materials. The system comprises two major system components, a customer developed inventory and sales management system and a third party accounting system. The two components can reside on different hardware and operating systems, but are interfaced permitting transactions of one of the components to be reflected in the other. The method and system also make use of business analysis and planning tools. These tools provide management with the flexibility of analyzing information relationships quickly and with less dependence upon traditional programmer developed reports. Standard production reports are available for covering the more routine requirements.

2. Background of the Invention

Historically, companies have employed a largely manual file based system to manage the procurement, handling and distribution of oil field country tubular goods materials (OCTG). A new trend in outsourcing of inventory procurement and handling is beginning to develop in the oil industry. As the OCTG activity levels increases, it becomes increasingly more difficult to maintain an effective control of the materials management process.

In light of the above, there is a need in the art for a method and a system that provides an effective control of the management process of sales and materials for oil field country tubular goods. Therefore, the present Tubular Information Management System (TIMS) has been developed.

### SUMMARY OF THE INVENTION

Accordingly, the invention is directed to a method and a system for forecasting material requirements and managing the accessibility of those materials utilizing parameters and processes used in the oil country tubular goods business. Therefore, the present invention substantially obviates one or more of the problems due to the limitations of the related art.

Effective OCTG material management requires a number of factors not common to the supply chain management. For example, prior consumption based models for OCTG are not accurate indicators of current and future requirements. Therefore, the present invention provides a consumer/distributor forecasting model based upon customer planned drilling schedules. The reality of oil/gas drilling practices is that initial plans are based upon imprecise knowledge of potential hydrocarbon reservoirs. As the drilling activities progress, there is increasing certainty as to materials needs. Consequently, a design criteria for the Tubular Information Management System (TIMS) is the creation of initial materials requirements as are indicated by the initial drilling forecasts. Inventory materials are allocated to these requirements so that needs are guaranteed by influencing supplier production schedules. Accordingly TIMS supports forecasted allocations.

Moreover, the progressive certainty as to material requirements as a function of drilling operations within the scope of the original plans requires a feedback mechanism to adjust initial assumptions. Thus the design criteria that permits the allocation of materials against the original requirement with the possible reallocation to more likely requirements is necessary. Therefore, the present invention provides an inter-forecast allocate/unallocate mechanism. Additionally, both the drilling plans and oil field country tubular goods materials production plans are necessarily long term. It is therefore necessary to allocate materials in such a manner as to insure that actualized drilling plans are satisfied while assuring that terminated drilling plans do not adversely impact materials stocking level as this would necessarily increase costs and would lead to long holding periods with the resultant materials deterioration. Thus, the requirement that allocations be associated with both on-hand and on-order materials is needed. TIMS tracks materials on-order and on-hand status and permits forecast allocations.

The invention TIMS also maintains dual units of measure, since OCTG materials are traditionally quantified by two different measures. Initial requirements typically are specified using units of length, while at the time of consumption these requirements are specified in terms of units of standard length (joints).

Also, since drilling activities span the globe, drilling operations are typically documented using measurement units used by the countries in which these operations take place. Thus, TIMS supports both English and Metric units of measure.

Another obstacle in the management of materials is that the initial purchase state of OCTG materials is not commonly the same as that required in the final delivery phase. Furthermore, there are a wide variety of materials necessary for finishing requirements that are specific to a given well drilling plan. Therefore, TIMS supports both the inspection and post-production fabrication activities.

Effective deployment of material to meet delivery needs requires that the state of the delivery be tracked accurately. Some activities are single stated, while others are dual stated. TIMS supports the tracking of materials in “in-process” states of “IN” and “OUT.”

In order that cost effective delivery be assured with information available to justify optimal pricing to the customer, it is necessary to monitor the major cost categories and communicate these cost values to the customer as support for cost plus pricing. TIMS maintains several cost categories, including raw materials, fabrication, shipping, and inspection.

The tracking of a wide variety of materials procurement, management, and delivery activities is a cumbersome activity. To minimize the labor required to maintain such a system, a tightly linked system is required. Therefore, TIMS supports extensive forward and reverse information flows.

The extensive process and sub-process activities spawn the need for the process managers to be alerted to changing states. TIMS modules contain an action, action date, user assignment, and field set that is automatically displayed to the originator (and assignee) when the defined action falls into a date window-reminder.

OCTG management involves a variety of activities, each involving measures of the material. The multiple measurement activities lead to variances that must be compensated within and across activities. TIMS supports both in-process adjustments (close adjustments) and cross-process adjustments (zero adjustment).

Supply Chain Management (SCM) activities can involve materials of multiple ownership's. The TIMS system supports the partitioning of inventory in association with one or more business interests. TIMS supports inventory group associations with specific owners.

OCTG delivery pricing may use various and different pricing models. TIMS system supports both distributor and custodial pricing upon delivery.

Conventional procurement, materials management, and delivery systems involve a variety of tracking forms and reports. These may involve one or more internal elements of an organization. The data input required to track these activities could become burdensome. TIMS supports user defined default data template values to pre-fill standard forms.

The maintenance and support of a global centric materials management system requires that modules present a flexible set of functions. Different operating entities may require functions not appropriate to another or the function may contain algorithmic differences. Upon being called by the user, each TIMS system module queries a site configuration lookup table to determine specific functions and function implementations. This permits one code implementation to serve multiple (global) operating entities. TIMS supports a site based function implementation.

An extensive set of reference (lookup) tables insures that minimal data entry is required and that standard values are validated to appropriate values only. TIMS performs extensive data validations.

The inventive system is a comprehensive materials procurement, management, and distribution system, and thus may contain privileged and confidential information. Therefore, it is necessary to constrain users to functions and data views appropriate to their functions. TIMS supports a user security level assignment that is used by system code to constrain user access.

A requirement of one of the TIMS sites is that material be consigned. The payment for this consigned material generally takes place in the form of a periodic interest payment and finally as a materials payment upon delivery. Multiple interest periods are allowed with the material coming into inventory and leaving during any two points in time. TIMS automatically calculates the appropriate interest payment and presents an itemized text log detailing the components of this interest payment at invoice generation.

The global implementation of TIMS requires that costs be maintained in terms of local currency types. TIMS supports the capture of cost data in arbitrary currency types.

Material may be purchased and duty suspended pending the determined final delivery point. TIMS documents the receipt and delivery duty status.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the present invention provides an inventory management system including customer inquiry/quotation means for obtaining inventory and non-inventory product information, forecasting means for identifying planned sales, sales order means for providing general information about the sale, the products, charges and services required to produce end products, purchase order means for receiving and providing product and specification information to the supplier and accepting and generating an identifier for the purchase, reporting means for presenting information to a user of the system, adjusting means for modifying inventory information, and, query means for viewing inventory and transaction information.

Furthermore, the present invention provides a method for forecasting future material needs, the method including creating a customer demand forecast, transforming the customer demand forecast into a materials requirements, making an inventory query, and fulfilling the materials requirements.

Additionally, the information management system also provides an inventory management system comprising an inventory and sales management means resident on a first hardware and operating system, an accounting means resident on a second hardware and operating system, and an interfacing means for permitting inventory-costing transactions to be shared and transferred between the inventory and sales management means and the accounting means.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 shows an inventory and sales management system of the present invention;

FIG. 2 shows an inventory/accounting interface system of the present invention;

FIG. 3 shows a process of the inventory/accounting interface system of the present invention; and

FIG. 4 shows a process of the inventory and sales management system of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawing to refer to the same or like parts.

The present invention provides a system and method for the effective control of the management materials process. Additionally, the invention provides an interface that allows the system to interact with a standard accounting system.

The Tubular Information Management System (TIMS) is presented to a user on a display. The main menu screen has several options for: (a) presenting the menu options; (b) displaying real-time inventory and sales information (security permitting); (c) displaying simple bar graphs of quote and sales achievements; (d) drilling-down on sales (sales invoice) and returns (customer returns).

The TIMS also comprises two major components. The first is a custom developed inventory and sales management system. The second component is a third party standard accounting system.

The TIMS inventory system consists of modules ranging from planning and purchase to sales and returns. The inventory system manages the inventory using both joints and feet (or other approved length units) as units of measure. When only a single unit of measure is known, a standard conversion value is used to produce the other. Inventory is maintained showing on-order, on-hand, available for sale, committed, and in-process quantities.

Most modules serve as a source for other modules. For example, the receiver module can be entered manually or called from the purchase order. When called from the purchase order, values are automatically carried forward minimizing the information that must be input by the user. Received quantities are posted back to the originating purchase order to reflect receipt status. Another example is that the sales order can be generated manually from the quote or from the forecast modules. The sales order, in turn, generates one or more invoices. Invoices become the source for customer returns, etc. Most modules progress through several states. For example, the user plans the quantity to be processed, releases this material, and finally tallies inbound/outbound material (as required). Finally, when the transaction is judged complete, the user closes the transaction. The prior transaction values are then automatically adjusted to agree with the inbound tally total.

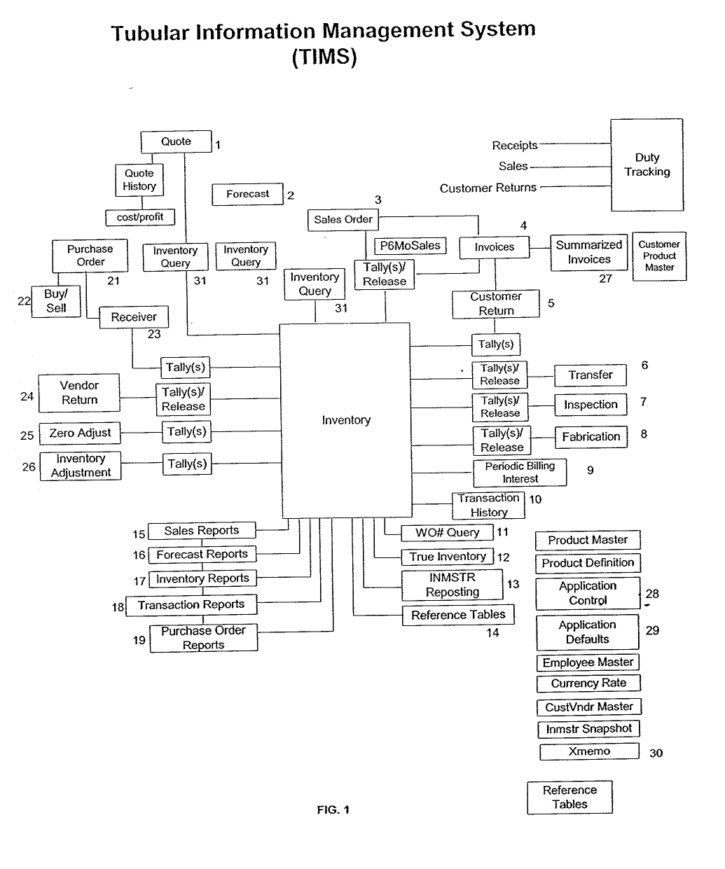

With reference to FIG. 1, a preferred embodiment of the system in accordance with the present invention includes a quote module (1) connected to a quote history (1a) and to a sales order (3). The quote module (1) permits TIMS to quote both inventory and non-inventory items. A quotation screen allows the salesperson to review previous quotes for the product being quoted. The salesperson can restrict the retrieved quotes by customer if desired. The quotation history identifies the sales order for any quote that subsequently becomes a sale. The sales order may be called from the quote history screen. In addition to the sales history, the current inventory of the product can be viewed. Optionally, the user can elect to see the newest purchase or the oldest remaining contract in inventory.

A cost/profit analysis screen can be called from the quote permitting the salesperson to review past sales of that product to determine the sales price, the cost of the sales, and the profit level. This information is presented for the past six months (further broken into three equal subintervals). This six-month default period can be changed to any time frame desired for a longer/shorter view. The purpose of this module is to provide historical evidence in support of current quotes and sales activities. It displays prior sales (in dollars and percentages), cost of inventory sold, and profit for the specified period. Other historic information will be known to those skilled in the art and are within the scope of this invention.

A forecast module (2) connected to the sales order module (3) permits identification of planned sales (forecast) and the allocation of inventory to that forecast. The forecast module can initiate a sales order. The sales order module (3) includes general information about the sale, the products, charges, and services required to produce the end product. From the sales order module transactions such as fabrication, transfer, or inspection can be initiated. The sales order displays estimated profit in total and by product. The sales order can be used to initiate either a pre-paid or a regular invoice. The cost/profit function described above (quote) is also available from this module. The sales order can be initiated either manually, from a forecast, or from a quotation.

The invoice (4) generated by the sales order (3) can be either a pre-paid or a regular invoice. This invoice is referenced when a customer return is created, resulting in the pulling of data into the customer return. The customer return (5) is the mechanism by which material is returned by the customer and credit is given to the customer. The user identifies the invoice and invoice detail item numbers and the remainder of information is drawn from that source. The user completes a yard tally documenting the quantity and condition of the returned material. Additional charges may be documented that reduce the credit given the customer.

The purchase order (21) system has two phases, the first being the requisition during which the product and its specifications are provided to the supplier. The second phase is the acceptance and issuing of a contract number for the purchase. Inventory is posted with the on-order quantity. Payment terms define the net (discounted) purchase cost. The net cost is posted to inventory. Purchase specifications can be input further defining the material being purchased. The user can call the receiver function from the purchase order if desired. If less material is received than the original order, then upon close the purchase quantity is automatically adjusted to the received quantity. Several fields at the purchase order master level are used to constrain or further define the detail items. The purchase order application consists of several parent/child record relationships. Fields entered into the top level (master level) are used to constrain detail relationships. When the purchase type field is set to [R]epurchase, a new purchase is created with the previously created purchase contract being appended with a suffix. This eliminates the need for the creation of a new contract number. Order limit control (21.a) compares current purchases and inventory limit values to determine if a given purchase is permitted without authorization override.

The receiver (23), which is connected to the purchase order (21), captures product delivery information. The receiver calls one or more tallies, documenting the specific instance of delivery, and captures the yard's work order number (used internally by the yard for identification). Receipts are posted to inventory and to the originating purchase order. The buy/sell view module identifies historical purchase pricing and the sales price for a product. A default interval is provided, but the user can specify an alternate interval if desired. The purpose is to permit the purchaser to view trends in purchase price as well as resale prices.

The vendor return module (24) allows material to be taken out of inventory for return to the supplier. The vendor return captures information specific to the return and calls a tally that documents specific instances of the product's return.

The buy/sell view module (22), which is also connected to the purchase order module (21), identifies historical purchase prices and the current sales price for a product. A default interval is provided, but the user can specify an alternate interval if desired. The purpose is to permit the purchaser to view trends in purchase price as well as resale prices.

The transfer order module (6) is the mechanism by which inventory is moved from yard to yard. The user specifies the product, the yards involved, the expected movement costs, and the quantity to be moved. The user then initiates a release of that material. Inventory reflects this release of material as in-process status of the inventory. The user, in turn, documents the outbound and inbound material via tally. When the transaction is closed the release and outbound values are adjusted by the system to equal the inbound tally values. Costs of the transfer are captured to inventory and become the source of inventory incremental cost transactions passed to the accounting system via the accounting interface.

The inspection/order module (7) is the means by which inventory condition (new, used, etc.) is changed. The process steps are analogous to those for the transfer shown above.

The fabrication order module (8) permits the modification of a mother goods design (MG) product into one or more finished goods design (FG) products. There are several system purposes involved in this process. One is to redefine the product since it has now been changed into another product. Another purpose is to document the mother goods materials that were consumed in the process of creating the new finished good or goods. Another purpose is to define the services and the costs of those services that are required to redefine the product. Thus, the services performed and the charges for those services are linked to each finished good. The charges are used to redefine inventory cost and are sent to accounting via an interface. A component of the application (the threading order) captures information specific to the “fabrication threading request” so that a threading requisition document can be created for the vendor. The threading operation (placement of different thread type on the ends of the pipe) is required to permit compatibility with other hardware that the customer uses to assemble a suitable well casing/well head design.

The periodic interest billing module (9) evaluates each inventory item's age against an established age limit table. When the holding period exceeds the predetermined limit, interest is charged. Several interest types are maintained each with an effective start and stop date and each with a different rate. For example since the carrying costs of materials is a function of prevailing bank interest rates, it is necessary to define a mechanism that permits the accurate recapture of these carrying costs. Periodically these rates are negotiated between buyer and seller and a mutually agreeable rate is established. Their rates have an effective “start date” and an effective “end date.” The TIMS system contains an interest calculation algorithm permitting the automatic determination of the effective interest rate between any two periods. This function can be enabled or disabled depending upon the TIMS instance in question. Since the TIMS application is a globally applied system and is deployed and used in many different customer relationships, it is necessary to enable or disable the function as the case may require. In the case where inventory carrying responsibility is a function of the seller only, then no such interest calculation is appropriate and hence the function must be disabled and when the buyer agrees to responsibility then the function is enabled. The “interest” referred to here consist of three independent interest types, each with an arbitrary number of interest periods, and defined per customer agreement. Each period may have a different interest rate. This rate is maintained in the appropriate interest rate table for easy maintenance and reference. Each interest type is also associated with values referred to as “g days” and “f days.” A “g day” is the amount of time that there is agreement between the seller and the buyer during which no interest is to accumulate. An “f day” value is the number of days that no interest will be charged if other conditions of the sale are met. These are contract specific values and are used to adjust the interest charge values.

The TIMS interest calculation is an automatic function and results from the user initiated event called “Generate Invoice”. The product being delivered is referenced back to the receipt date and the delivery date and this date interval is projected on interest intervals. Calculations of “g days” and “f days” together with the number of days in any given interest interval times at the appropriate period interest rate results in the charged interest amount. This value, together with a concatenated interest element list is inserted into the invoice.

The transaction history module (10) categorizes transactions by month into sales, purchases, transfer, etc. The function is used to track changes to inventory items.

The Work Order Number (WO) query sub module (11) permits the user to view yard inventory from the perspective of the yard using the yard work order number as key. The yard work order number is included on each tally. In order that there be an effective communication between the TIMS inventory manager and the “yard” entity actually holding the inventory, it is necessary that an inventory link be established between two parties. The holder (yard) is required to provide a reference to that facility internal reference. When the inventory is processed within TIMS, reference to the holder's reference permits this required synchronization. The work order number (WO query) application tracks inventory in terms utilized by the holder of the material thus facilitating this required communication.

The true inventory view module (12) provides the user with information as to location, cost, and transactions (current and historical) for an item.

The INMSTR reposting module (13), allows the materials manager to add an inventory stub for materials previously removed via the zero adjustment process. No quantities or cost values are permitted in this function, as other modules are then appropriate to complete the task. The “zero adjustment process” is a consequence of there being multiple measurements by different interests throughout the inventory management process. Since not all of these measurements may be in agreement, in the end, there may be apparent material overages or underages. The zero adjustment process permits the accumulation of these values to be quantified and dealt with properly in the accounting system.

There is extensive validation and data retrieval relating to customers, products, accounting codes, yard codes, etc., within the TIMS system. The provided reference tables (14) are used to capture this information, which includes: accounting codes, address codes, charge codes, customer/vendor codes, country/state codes, entity master, format/commodity codes, inspection type codes, material type codes, pay terms codes, product length to joint, quote terms, service codes, sales plan values, yard code master, application defaults, application authorization, company codes, customer product codes, currency conversion rate, customer group codes, delivery terms codes, expense codes, pipe grade values, map accounting/company/entity, mill codes, product code master, project code master, size labels, unit conversion, miscellaneous lookup values, tax rate table, application control, and application information.

The sales order reports module (15) is used by the TIMS to identify sales activities. The forecast report module (16) documents the forecast process. The inventory reports module (17) details the inventory by product, type, etc. The transaction reports module (18) shows the current open transactions pending for inventory items. The purchase order reports module (19), displays purchase information for pending/in-process purchases.

The zero adjust module (25) is an inventory cleanup function that serves to remove contracts that are fully sold from inventory. There may be residual footage (and costs) which remain due to measurement errors by the movements into and out of yards. The costs associated with this removed material are posted to accounting as an inventory adjustment. An inventory adjustment module (26) is also provided in the TIMS. This module allows materials management to make adjustments to inventory to reflect audited levels. The adjustment is assessed and is used as a separate accounting adjustment to inventory.

A summarized invoice module (27) permits the selection of an arbitrary (date interval selection) number of detail invoices to be collected and billed as one. The summarized billing application also allows exclusion of one or more invoices from the selected invoices maintaining payment history.

The TIMS system can be deployed in many different locations. Each location may have unique requirements, however the distributed TIMS code is common to all locations. The application control table (28) permits different functionality to be implemented at each site. Obvious examples of this variability that must be accounted for are metric vs. English units of measure, currency types and sales billing methodologies. The application defaults table (29) contains user updateable default values for many of the fields common to many of the applications, such as company, office, department codes and units of measure, etc. Many of the applications are programmed to retrieve these default values upon startup.

Xmemo (30) is the sales and purchase memo function that passes inventory costing information between the TIMS inventory system and the SCOA mainframe. This is done in the form of an upload to the mainframe. The inventory query module (31) is called from other modules. Its function is to permit a salesperson to view current inventory and transactions, such as pending sales or forecast allocations. This module is the interface between other modules and the inventory, and is used to define the product and quantities to be allocated. Inventory reflects these quantities as committed inventory.

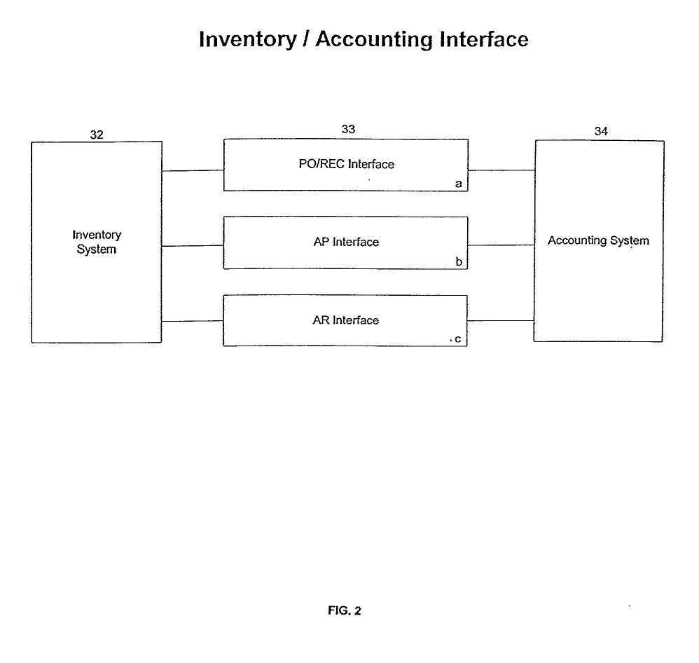

FIG. 2 shows the Inventory/Accounting Interface, which includes inventory system (32), interface (33) and accounting system (34). The interface system (33) comprises three modules, a PO/REC module (33a), an AP module (33b), and an AR module (33c). The interface modules use inventory cost transactions to post accounting transactions.

The PO/REC interface module (33a) uses inventory purchase orders and receivers as the source of these transactions. This permits the accounting system to reflect potential and received liabilities. The candidate data is selected, transformed, validated and posted into accounting system structures.

The AP interface module (33b) takes as source those transactions that add cost after the receipt of inventory (i.e. transfers, fabrications, etc.) and after selection, transformation and validation occurs, passes this information into the appropriate accounting system tables.

The AR interface module (33c) takes candidate transactions (invoice and customer returns) from the inventory system (selectable by date, type or specific item), transforms, validates, and passes the information into the format/content required by the accounting system.

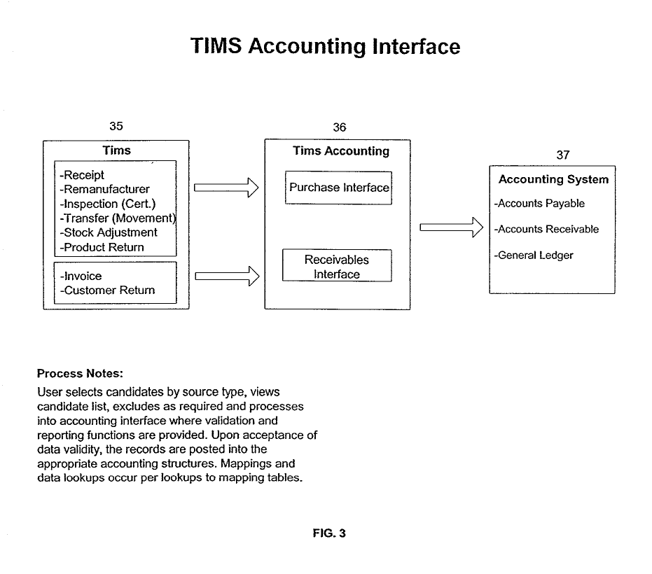

FIG. 3 shows the functioning process of the inventory/accounting system of FIG. 2. The user selects candidates from the inventory system (35) by means of the display such as candidates by source type, views candidate list, and excludes as required any other type of information. Thereafter, the system processes the information into the accounting interface (36) where validation and reporting functions are provided. Upon acceptance of data validity, the records are posted into the appropriate accounting structure (37). Mappings and data lookup occur per lookup to mapping tables. Accounting requires that costs be accumulated and posted to specific accounts as are needed to establish profitability for the various market segments. The module permits accounting to process selectively these major categories for posting from the TIMS to the accounting system.

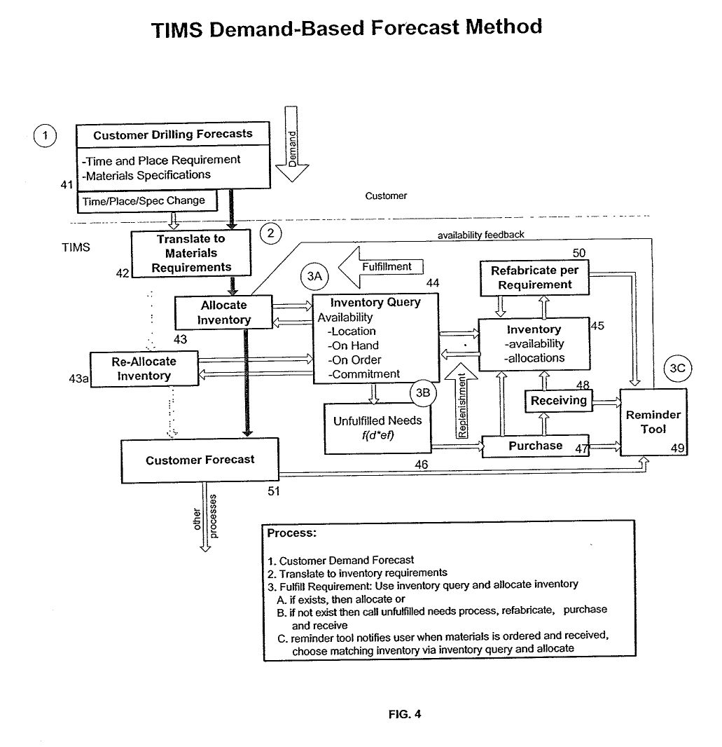

FIG. 4 shows the TIMS demand-based forecast method. Initially, a customer drilling forecast (41) is generated based on several requirements including (a) time and place requirements and (b) materials specifications. Thereafter, the customer drilling forecast is converted into a materials requirements (42), and allocating the inventory (43) fulfills the order. Prior to fulfilling the order, an inventory query (44) is made wherein the availability of the materials is checked based on location, on hand, on order, or on commitment. If after the inventory query is made and it is determined that the order cannot be fulfilled from the existing inventory (45), alternative measures are taken. For example, if the order cannot be fulfilled, an unfulfilled needs process (46) is activated, wherein the missing materials are purchased (47). After purchasing and receiving (48) the materials, they are added to the inventory (45) and the order is fulfilled. A reminder tool (49) notifies the user when materials are ordered and received. Alternatively, if the materials are not purchased, the materials can be fabricated (50), and added to inventory (45). Once the materials have been added to inventory, the order is filled and the customer forecast (51) is completed. An alternative to the ordering of new material may be the selective reallocation of materials from one pending order to another. Then at a later date, should it appear likely that additional materials are required, then those materials are placed on order to replace the materials just reallocated. Thereafter, the information obtained from the forecast can be used for other processes.

While the invention has been described in detail and with reference to specific embodiments thereof, it will be apparent to one skilled in the art that various changes and modification can be made therein without departing from the spirit or scope thereof. Thus, it is intended that the present invention covers the modifications and variations of this invention provided they come within the scope of the appended claims and their equivalents.

What is claimed is:

1. An inventory management system comprising:
customer inquiry/quotation means for obtaining inventory and non-inventory product information;
forecasting means for identifying planned sales;
sales order means for providing general information about a planned sale, products, charges and services required to produce end products in the planned sale;
purchase order means for receiving and providing information to a supplier and accepting and generating an identifier for a purchase for the planned sale;
reporting means for presenting information to a user of the system;
adjusting means for modifying inventory information; and,
query means for viewing inventory and transaction information.

2. The inventory management system of claim 1, wherein the customer inquiry/quotation means further comprises:
quote history means for reviewing previous quotes for a product being quoted and a current inventory of the product; and,
cost/profit means for reviewing past sales of the product.

3. The inventory management system of claim 1, wherein the purchasing means further comprises:
buying/selling means for identifying historical purchase pricing and sales prices for a product; and,
receiving means for capturing product delivery information.

4. The inventory management system of claim 1, wherein the reporting means comprises:
sales reporting means, forecast reporting means, inventory reporting means, transaction reporting means, and purchase order reporting means.

5. The inventory management system of claim 1, wherein the adjusting means comprises:
zero adjusting means for removing contracts that are fully sold from inventory; and,
inventory adjusting means for making adjustments to inventory to reflect adjusted levels.

6. The inventory management system of claim 1, wherein the query means comprises:
inventory query means for viewing current inventory and transactions;
true inventory query means for viewing information regarding location, cost, and transactions for an item; and,
work order query means for viewing inventory using a work number as key.

7. The inventory management system of claim 1, further comprising:
invoicing means for pulling data from the inventory into a customer return when the customer return is created.

8. The inventory management system of claim 1, further comprising:
customer return means for crediting a customer when product is returned; and,
vendor return means for taking product out of inventory and returning product to a supplier.

9. The inventory management system of claim 1, further comprising:
transferring means for moving inventory from yard to yard.

10. The inventory management system of claim 1, further comprising:
inspecting means for changing inventory condition.

11. The inventory management system of claim 1, further comprising:
fabricating means for modifying a mother good product into one or more finished goods.

12. The inventory management system of claim 1, further comprising:
periodic interest billing means for evaluating an age of each inventory item against an established limit and charging interest when a holding period exceeds a predetermined age value.

13. The inventory management system of claim 1, further comprising:
transaction history means for identifying sources of inventory cost by type.

14. The inventory management system of claim 1, further comprising:
repost means for allowing products previously removed to be added to inventory by the zero adjustment means.

15. The inventory management system of claim 1, further comprising:
reference means for capturing information.

16. The inventory management system of claim 1, further comprising:
invoice summarizing means for selecting an arbitrary number of detail invoices to be collected and billed as one.

17. The inventory management system of claim 1, further comprising:
application control means for allowing different functionality to be implemented at different sites.

18. The inventory management system of claim 1, further comprising:
application default means for storing user updateable default values and retrieving said values upon startup.

19. The inventory management system of claim 1, further comprising:
a sales and purchase memo means for passing inventory costing information between an inventory system and a mainframe.

20. An inventory management system comprising:
an inventory and sales management means resident on a first hardware and operating system;
an accounting means resident on a second hardware and operating system; and,
an interfacing means for permitting inventory-costing transactions to be shared and transferred between the inventory and sales management means and the accounting means.

21. The inventory management system of claim 20, wherein the inventory and sales management means comprises:
quoting means;
forecasting means;
sales ordering means;
invoicing means;
returning means;
adjusting means;
querying means;
reporting means.

22. The inventory management system of claim 20, wherein the interfacing means comprises:
an AR interface module;
an AP interface module; and,
a purchase order receiver interface module.

23. The inventory management system of claim 22, wherein the AR interface module takes candidate transactions from the inventory sales and management means, transforms and validates the candidate transactions into a format/content required by the accounting means and passes the candidate transactions to the accounting system.

24. The inventory management system of claim 23, wherein the AP interface module records transactions that add cost after receipt of inventory, and after selection, transformation and validation of the transactions, passes said transactions into an appropriate accounting system table.

25. The inventory management system of claim 22, wherein the purchase order receiver interface module selects, transforms, validates and posts candidate data into accounting system structures.

26. A method for managing materials, the method comprising the step of:
interfacing an inventory sales and management system and an accounting system resident on different hardware and operating systems.

27. The method of claim 26, wherein the step of interfacing comprises:
taking candidate transactions from the inventory sales and management system, transforming and validating said candidate transactions into a format/content required by the accounting system and passing said candidate transactions to the accounting system.

28. The method of claim 26, wherein the step of interfacing comprises:
taking from the inventory sales and management system transactions which add cost after receipt of inventory; and,
selecting, transforming, validating, and passing said transactions into an appropriate accounting system table located in the accounting system.

29. The method of claim 26, wherein the step of interfacing comprises selecting, transforming, validating and posting candidate data into accounting system structures located in the accounting system.

30. A method for forecasting future material needs, the method comprising the steps of:
creating a customer demand forecast;
transforming the customer demand forecast into a materials requirements;
making an inventory query; and,
fulfilling the materials requirements.
